(19) United States
(12) Patent Application Publication
(10) Pub. No.: US 2012/0105367 A1
(43) Pub. Date: May 3, 2012

(54) METHODS OF USING TACTILE FORCE SENSING FOR INTUITIVE USER INTERFACE

(75) Inventors: Jae S. Son, Rolling Hills Estates, CA (US); David Ables, Venice, CA (US); Bob Cunningham, Plano, TX (US)

(73) Assignee: IMPRESS INC., Los Angeles, CA (US)

(21) Appl. No.: 13/280,672

(22) Filed: Oct. 25, 2011

Related U.S. Application Data
(60) Provisional application No. 61/408,737, filed on Nov. 1, 2010.

(51) Int. Cl. G06F 3/044

(52) U.S. Cl. 345/174

(57) ABSTRACT

Described are novel methods of user interface for electronic devices using proportional force information. The new user interface is more intuitive, easier to use and requires less finger manipulations. The input device itself is configured for detecting at least one location of touch and measuring a force of touch at this location as in a capacitance sensing tactile pressure array. At least two events defining an output event of the input device are provided for a particular location. Selection of one event or the other is done based on a force of touch being either above or below a predetermined force of touch threshold. More than one force of touch threshold may be provided for one or more locations, along with a corresponding number of events—to further increase the functionality of the input device. The invention may be used in particular with laptop, tablet computers and smartphones.

### CROSS-REFERENCE DATA

This application claims priority benefit from a provisional application No. 61/408,737 filed 1 Nov. 2011 with the same title, which is incorporated herein in its entirety by reference.

### BACKGROUND

Described herein are novel methods of designing a user interface for electronic devices using proportional force information. The new user interface is more intuitive, easier to use and requires less finger manipulations. These methods are novel in part because reliable input sensors capable of detecting a proportional force, i.e. how hard the user presses a button, have not yet been widely available.

Touch screen technologies have evolved in both cost and functionality that allowed them to expand into new markets such as personal mobile devices for small touch displays and all-in-one large computers that feature touch displays of large size. Newer and faster integrated circuit controllers that form a computing foundation for touch screen capabilities have allowed increasingly complex and novel improvements in user experience as well as development of new applications. One specific improvement that has been extensively developed and broadly adopted by consumers is the ability to provide simultaneous multi-point touch input.

Multi-point touch can be categorized as either a dual-touch or a true multi-point touch. In dual-touch applications the touch screen digitizer is typically configured to calculate the midpoint of two independent simultaneous touch locations. Typically the user places a thumb and pointer finger of the same hand or one finger of each hand on the screen and moves them independently. Usable input parameters provided by dual-touch manipulation are typically the midpoint and distance between the two touch locations. This information provides a new level of input data in the X and Y plane for the user interface developer allowing contemplation of novel applications for user interface design. Similar to dual-touch features, a true multi-point touch provides similar input parameters of midpoint and distance but also includes discrete x,y coordinates for each finger. Multi-point touch input is capable of providing data points for more than 2 input locations and may go up to 10 or more depending on the end use case. For example, a large wall display can be configured to have two or more persons using all their fingers on the same screen for typing on virtual keyboards all at the same time.

These technology improvements as described above have provided increased functionality and have opened a new age of interactive user experience and functionality. However, these improvements try to utilize distance and movement between touch locations as a way to simulate three-dimensional inputs on a two-dimensional sensing platform. Almost all touch screen implementations today provide only X and Y coordinate input and cannot provide a true 3-dimensional input of dynamic X, Y, and Z space. In some ways, this places an artificial restriction on how a user can ultimately interact with touch screen devices. Explained below are a few of the more popular and basic user functions to illustrate an idea of how a true 3-dimensional input capability can transform the user experience to a new level of interaction with the device and its intuitive control.

### SUMMARY

Accordingly, it is an object of the present invention to overcome these and other drawbacks of the prior art by providing novel methods of operating user input devices configured to provide locations and force of touch measurements.

The methods of the invention allow operating an input device such as a smartphone front panel. The input device itself needs to be configured for detecting at least one location of touch as well as measuring a force of touch at this location, for example as done by a tactile pressure sensor array. Such array is typically adapted to sense capacitance between two electrode layers.

In embodiments, at least two events defining an output of the input device are provided for a particular location. Selection of one event or the other is done based on a force of touch being either above or below a predetermined force of touch threshold. This force of touch threshold is selected to be within the operational range of the touch screen defined as above the initial detection level of force and below a level of force saturation.

In other embodiments, more than one force of touch threshold may be provided for one or more locations. In that case, a corresponding number of events may be provided such that depending on the measured level of force of touch a certain output even is selected.

Yet in other embodiments, additional selection criteria may be used such as duration of time during which the force of touch was above or below a certain threshold.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a concept behind binary control event generation;

FIG. 2 shows tactile control event generation for binary input;

FIG. 3 illustrates a drawing program with overlaid tactile controls;

FIG. 4 shows a chart of touch force as a function of time for a Select and Drag Tactile Gesture;

FIG. 5 shows a force vs. time chart for a Force-Sensitive Scroll Gesture;

FIG. 6 shows a force vs. time chart for a Pan-and-Zoom Force Gesture;

FIG. 7 shows a force vs. time chart illustrating a concept of an adaptive threshold increasing to match actual level of user input;

FIG. 8 shows a force vs. time chart where the threshold is decreasing to match the detected user input errors; and

FIG. 9 shows one example of implementation architecture for the methods of the invention.

### DETAILED DESCRIPTION OF THE PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The main idea of the invention is to provide a method of operating an input device, in which the device is configured for detecting at least one location of touch as well as measuring a force of touch at this location. A tactile pressure sensor array based on sensing capacitance between two electrode layers may be used as an example of such devices. Such a sensor array may be designed as a two-dimensional matrix capable of detecting having an X and a Y coordinate of one or more locations of touch and at the same time the sensor may be configured to independently and simultaneously measure the force of touch at each touch location.

One novel aspect of the invention is measuring the force of touch and categorizing it to be either above or below at least one predetermined force of touch threshold. That force of touch threshold is selected to be within the operational range of the touch-sensitive input device. Depending on whether the level of measured force of touch falls into a first or a second range (defined as above or below that threshold), the device may be configured to select either a first event or a second event as an output of the input device. In embodiments, more than one threshold may be used so that more than two events may be used for selecting the output of the device as illustrated in more detail below.

In yet other embodiments, the absolute level of force may be used as an input parameter if it falls above or below at least one predetermined force of touch threshold. In further embodiments, if the force of touch falls into a predetermined continuous measurement interval, the response of the input device may be selected accordingly. In yet other embodiments, the force of touch may be measured continuously and the change in that force may be used as defining the output as being either a first or the second event. For example, if the force of touch at a particular location is changing to cross over a predefined threshold, this may be used to select the event defining the output of the input device.

The method of the invention in its most general form comprises a step of selecting a first event or a second event as the output of the input device based on detected location of touch and the level of force of touch at this location being above or below at least one predetermined threshold.

### Specific Examples of Implementation

### Pinch Gesture (Zoom and Pan)

The pinch gesture feature provides a way to implement a dynamic depth function for viewing pictures or documents either up close or far away. The present invention provides for a 3^{rd} dynamic data range input to correlate between zooming in or out. The user may be asked to place two fingers on the display to activate the zoom in/out function. Examples of implementing this function according to the prior art are as follows:
To zoom out, user needs to move closely placed fingers away from each other while maintaining contact with the displayed content (picture, document, or website);
To zoom in, user needs to place two fingers close together and then spread them apart;
The Pan function may be usable with 1 or 2 fingers, but may be more functional with one finger—the user needs to continuously manipulate and reposition their fingers to use these functions.

According to the present invention, the user experience can be greatly enhanced by using a single finger instead of using multiple fingers to simulate a dynamic depth input parameter. Similar to using a finger in 3D space, force sensing allows the user to “push” the picture away or “pull” the picture in closer. The degree of zoom may be defined by the level of force that is exerted on the touch screen. In addition, the user is capable of using a single finger to simultaneously pan, zoom and rotate, just like one would do when manipulating or pushing an actual object.

### Copy and Paste

The copy/paste feature is essential for editing or preparing documents and emails with content from several sources such as other documents, emails, multi-media content, pictures, internet postings or web pages. This and similar functions require multiple touch events and sometimes complex manipulation of content on the screen. The sequence of events includes highlighting and selecting content, followed by moving selected content, then followed by saving or deleting the content as desired. Several popular user interfaces and touch screen technologies of the prior art allow this function to be accomplished in the following way:
User double taps near target text or content and a menu bar pops up on the screen with the following selections: CUT/COPY, PASTE;
The display shows graphic end points around target text or content;
The user is required to manipulate these graphic end points separately to exactly highlight the text or item to be cut or copied;
User then selects the desired function on menu bar (i.e. cut/copy/paste);
Selection is stored until the user again double taps to bring up the pop-up menu bar (in either the current or new app/document).

With a true 3D capability afforded by the methods of the present invention, the user experience can be greatly enhanced by using a single finger instead of using multiple fingers or multiple operations to select and manipulate target content. This intuitive operation can only be accomplished with a dynamic depth input parameter in the Z-axis through force input. Similar to using a finger in 3D space, the force of touch sensing allows the user to immediately select and highlight the desired content at one time. One way to accomplish this may be configured using multiple force levels to define different events at the same location of touch. A lighter force of touch may be used to highlight all of the desired content, while a subsequent heavy or quick push after selection may be used to simulate a grab (or final selection) of the target content. The content may then be automatically placed into the device memory to be used later.

### Scroll Wheel/Slide Bar

A primary example for using this feature is with a multi-media content such as a virtual album of songs and group of videos. Current touch screen technologies only provide a one-dimensional control function and at most a two-dimensional cursor control for scrolling through content. In addition to basic searches, lists can include additional levels, activated through force threshold events, that describe their content in greater detail, which should also be considered. For example, a song can be categorized by genre, artist, year, etc. or additional background information on a song or artist can be linked to each listed item. One essential user enhancement for scrolling may be controlling the rate of scanning through a list. Several methods of the prior art are described as capable of changing a rate of scrolling or other control functionality:
Increasing or decreasing finger movement/speed on a sensor surface;
Repositioning finger at different distances away from a “center” position;
Utilizing timing of sensor activation, i.e. speed increases with activation time.

A circular scroll gesture which allows the user to continuously rotate the finger as if on an iPod wheel is better than pressing a button multiple times in a repeated fashion. However, for very large list of songs the number of times the person has to make a complete circular motion becomes burdensome so time-based acceleration is implemented in the prior art—a number of songs scrolled for one revolution increases after several rotations. Similarly, a button interface can implement the same type of acceleration features when holding down the button such that the list steps through the songs with increasing speed. The problem with this implementation is that there is no easy way to decelerate and so often times the user has to concentrate on looking at the fast scrolling information to try and stop as close to the desired location as possible and correct for either an overshoot or an undershoot. The flick gesture for scrolling through a list maybe fun, but it is not a very accurate way to reach the desired song.

The present invention improves the user experience by allowing using a single finger for this function. Acceleration function of the prior art was designed individually depending on the type of list being searched or on how the scroll feature is designed. Having the capability to simulate a dynamic depth input parameter may be used to provide an intuitive experience. The rate of scroll may be either increased or decreased based on the level of force of touch. In embodiments, one can increase the rate of search by gently increasing the pressure exerted on the touch surface. In other embodiments, if there are several identifying levels to a list, such as rock and country songs, one can use different tap thresholds to change type of songs within a specific list. Yet in other embodiments, a combination of force level and duration can enable purchase requests or background information can be displayed for each item on a list.

### Translating User Input to Device Response and Function

A typical conventional user input device, such as a mouse or touch pad, uses a switch to provide actionable input. In this case, the switch is either pressed or released, which can be considered as a “binary input”.

The application framework or operating system may generate different events based on these user inputs, which define instances where the application may optionally execute certain functions. Table 1 shows an order in which events may be generated by a mouse or other input device for a typical implementation.

TABLE 1
Typical Pointer Event Order of the Prior Art

| Event | Example |
|---|---|
| Arrive | Pointer moves over control area |
| Down | User clicks button while over control |
| Move | User moves pointer within control |
| Up | User releases button |
| Leave | Pointer moves out of control area |
| Click | Shortcut to implement click functionality |
| Double Click | Shortcut to implement double-click functionality |

With each event, the application framework or operating system typically provides the x,y location at which the event occurred, as well as optional additional information, such as the state of mouse buttons, keyboard buttons, scroll wheels, etc.

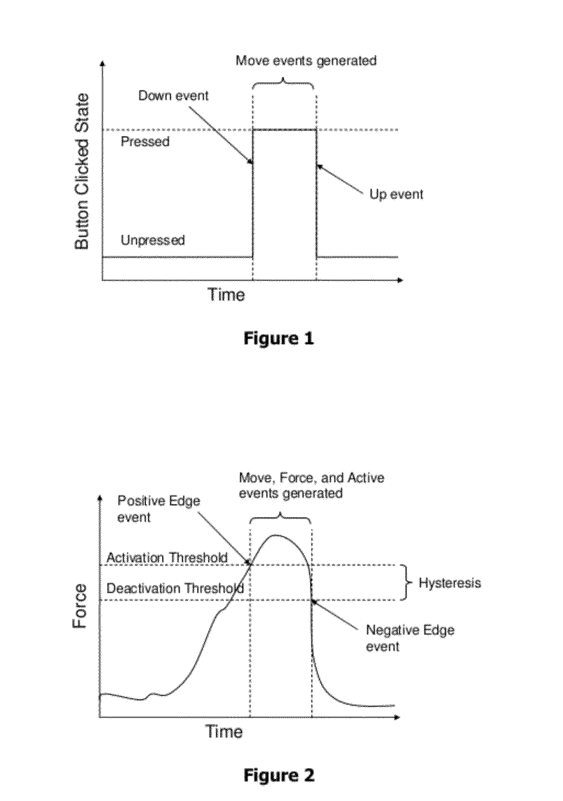

The events “Click” and “Double Click” are a somewhat special case, as they may be placed in different locations within the event order depending on the particular framework or application design. For instance, the “Click” event could be generated right after the “Down” event to respond when a mouse button is pressed, or it could be generated right after the “Up” event to respond when the mouse button is released. Applications may also have different criteria for events such as “Click” or “Double Click,” such as whether or not to respond if the mouse button is released when the input pointer has moved outside the control region, or what sort of time is required between successive clicks to generate a Double Click event—see FIG. 1.

A “tactile control” method of the invention includes an input region in which at least one or even several specific force of touch thresholds may be defined to generate events associated with user input, where an “event” is a set of functionality which is executed when its operating conditions are met. By selectively defining different combinations of thresholds and events, a tactile control can be used to implement a wide variety of user input, from the very simple mimicking of a button to very complex force-sensitive gestures.

A “tactile control” is then defined as a region of input space in which one or more force of touch thresholds are defined, each of which is associated with its own set of events. An example of a set of tactile events is given in Table 2.

TABLE 2
Event Generation for Tactile Control Threshold

| Event | Example |
|---|---|
| Arrive | Pointer location enters control area at or above the |
| | activation force of touch threshold. |
| Positive Edge | Increasing force of touch crosses an activation threshold |
| | while within the specified region |
| Move | Pointer location changes |
| Force | Applied force level changes |
| Active | Allows processing location and force as new tactile data |
| | is generated |
| Negative Edge | Decreasing force crosses a deactivation force of touch |
| | threshold |
| Leave | Pointer location exits control area at or above the |
| | activation force of touch threshold |
| Click | Shortcut event for triggering an action |
| Double Click | Two clicks within a specified time and with a specified |
| | minimal amount of movement between them |

With each, the application framework or operating system may provide the level of the applied force in addition to the X and Y position and other standard information typically collected by such systems.

This series of events is very similar to those generated by a binary input control, with two key additions. “Move” is identical in concept to the traditional Move event generated when the pointer location changes while over a control. “Force” is analogous and is caused when the applied force of touch to the control changes. “Active” can optionally be called whenever new tactile data is generated, which would typically be on a continuous basis.

One benefit of the “Active” event is that it enables different types of input gestures that may be time-dependent as well as force- and/or location-dependent. For example, many desktop applications feature “tool tips”, which appear when a user holds the pointer over an icon or other control. If the pointer remains still for a sufficient time, the tool tip is displayed to provide additional information, and when the pointer moves, the tool tip disappears. A tactile equivalent may be to hold the force over a threshold for a specific amount of time which may be typically shorter since the force level also helps to identify the desired action, at which point additional information may be displayed, or even different control functionality offered.

As with a typical binary input control, the “Click” and “Double Click” events of the invention may be defined to trigger on either the rising or falling edge of activation, depending on what is most appropriate for a particular application.

To avoid accidental repeated activations, a tactile control may further include a value for “hysteresis” in addition to the activation threshold. The “Positive Edge” event may be triggered when the force of touch rises above the predetermined activation force of touch threshold, while the “Negative Edge” event may be triggered when the force of touch drops below the activation threshold minus the amount of hysteresis. This allows the control to not respond to noise in the force signal generated either by electrical interference or by a non-smooth input from a user.

In addition to registering event handlers and setting the force of touch threshold and hysteresis, there are several other parameters that may be implemented to fit the needs of a particular application. For example, having multiple thresholds may be associated with multiple sets of Move/Force/Active events at each threshold. An implementation would have to define whether such events would be passed on to successive thresholds or not, as well as the order in which to process them.

### Example 1

### Binary Pushbutton Input

A tactile control may need to implement a standard pushbutton operation, which is easily accommodated by the described framework. This may be done simply by defining a single threshold without using Force or Active events. The threshold would be chosen based on how much force was desired to activate the control. As with a traditional input device button, the application framework would determine whether the “click” event was activated on the rising or falling edge—see FIG. 2.

### Example 2

### Different Actions Based on Force Level

To move a physical item (for example a brochure located on a desk) with a finger, the user needs to apply sufficient force to overcome friction between the brochure and the desk. This means that a light touch will cause the finger to slide over the brochure, but pressing harder will cause the brochure itself to move across the desk. This natural behavior of real-world objects may be simulated in a user interface by measuring the force that the user applies onto the input device surface. While an ability to move the cursor is not as widely applicable in touch screen applications since the pointer location is taken directly from the screen rather than from a pointing device, this ability could prove important for touchpads and for applications where the cursor location may change the way in which an object behaves.

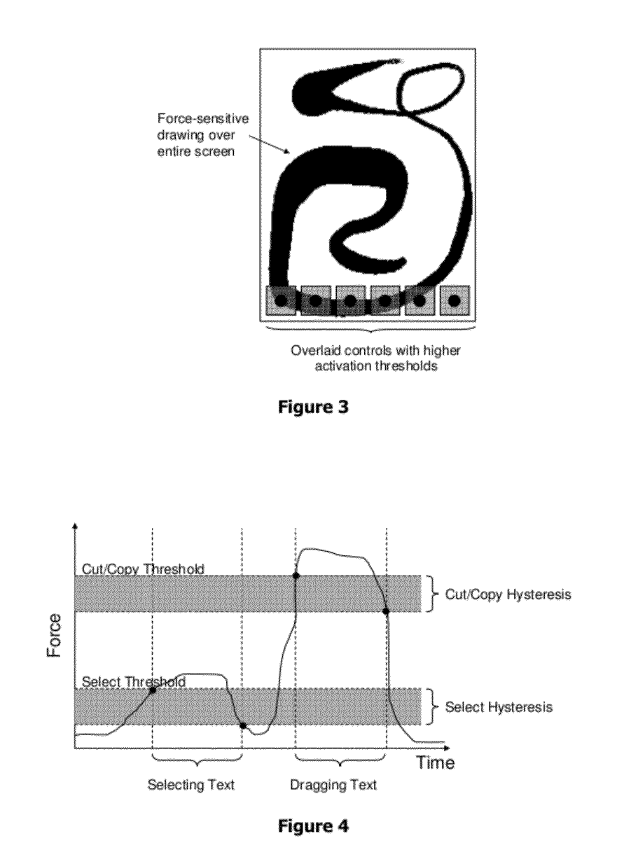

In embodiments, tactile controls may be overlaid to provide multiple functions in the same screen area by defining different activation thresholds. For example, an intuitive drawing application could allow drawing lines in which thickness may be based on the amount of pressure applied over the entire touch screen area. At the same time, different controls for changing the color or style of the line may be located within the drawing area and associated with higher activation thresholds than the drawing area itself so that the entire screen could be used without accidentally activating any of the controls—see FIG. 3.

Yet in other embodiments, a virtual stack of items on a display screen can be manipulated individually or together depending on the level of force applied. For example, if a stack of virtual playing cards is displayed on a screen and a player has a choice of picking one, three, or five cards from the stack, three force levels may be used to simulate the increased friction between the cards so the appropriate number of cards are chosen from a single movement. Another embodiment could be in an e-Reader device, where the amount of force applied in a “swipe” motion may determine how many pages would be turned, a gesture directly mimicking the type of physical gesture used when browsing the pages of an actual book.

### Example 3

### Select, Copy/Cut, and Paste

In embodiments, the function of select, copy/cut, and paste text may be realized by using light pressure to control the cursor location at the start of the selection and then using harder pressure for text selection such that the end location can be determined by the user. Once the text block has been highlighted, higher pressure applied to the selected text itself may allow the text to be moved to the desired location. A double-click may be used to implement copy or delete functionality as required by the application.

To implement this functionality in a tactile control, two thresholds may be defined over the entire text area, one for a Select and one for a Copy/Cut action.

TABLE 3
Select Threshold Events

| Event | Action |
|---|---|
| Rising Edge | Capture the current location in the text to determine one end |
| | of our selection. |
| Move | Whenever the location changes, update selected text to |
| | include everything between the current location and |
| | the initial point captured on the rising edge. |
| Falling Edge | Stops updating the selection length. |

For the a cut/copy threshold, a time duration parameter may be specified to determine whether a Double Click action had been performed to change from a Cut mode to a Copy mode. A Double Click in this case would be defined as two rising edges within the specified time duration.

TABLE 4
Cut/Copy Threshold Events

| Event | Action |
|---|---|
| Rising Edge | Set a timer to detect a double-click event and initialize in |
| | cut mode. |
| Move | Update our display to indicate the new text location. |
| | If we are in cut mode, simply move the text. If we are |
| | in copy mode, insert a new copy of the text at the |
| | current location. |
| Falling Edge | Leave the text in its current location. |
| Double-Click | Change from cut to copy mode. |

For applications where clipboard-like functionality is needed to store cut or copied data, the applied force may be used to indicate the “paste” location, for instance by detecting a higher-force “click” gesture within a body of text where nothing was currently selected—see FIG. 4.

### Example 4

### Force-Sensitive Scrolling and Select

Another useful user interface that can be implemented with proportional force sensing is the ability to scroll through long lists such as a phone list or songs in a precise manner. Two buttons are used to determine the direction of scroll, but because the level of force is detected, the speed may be determined based on the force that the user applies thereto. This would allow a hard press to scroll very quickly until the approximate region was reached, and then by softening the press, the user could slow down for easier selection of a specific item. The same control button may then be used to select the item in the list. The advantage of this arrangement is that the user works less and reaches the desired selection more quickly.

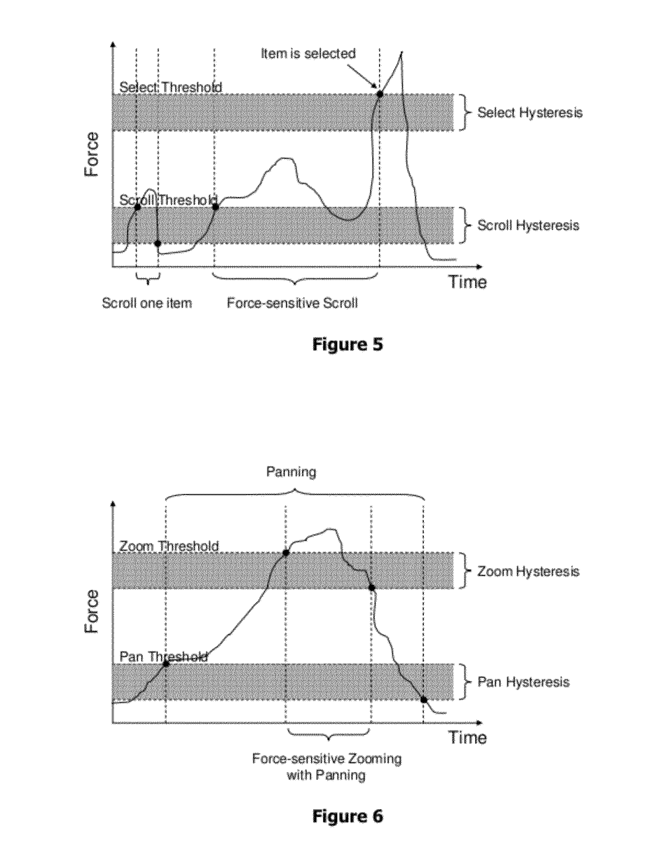

A tactile control method of the present invention may also be used to vary the scroll speed based on the amount of force applied to the control. To implement this, two thresholds are defined, one for scrolling and one for selecting. For the scrolling threshold, events are defined for Rising Edge, Falling Edge, and Active. A time duration may be further specified which must elapse before the force-sensitive scrolling becomes activated—see FIG. 5.

TABLE 5
Scroll Threshold Events

| Event | Action |
|---|---|
| Rising Edge | Starts a timer to determine the duration of the |
| | activation. |
| Active | If the timer is past the duration threshold, scrolls the list by |
| | an amount determined by the applied force. |
| Falling Edge | If the timer was past the duration threshold, stops scrolling. |
| | If the timer was not past the duration threshold, scroll |
| | down by one item. |

The timer may allow using a gentle “tap” to scroll by one item or a longer press to initiate a force-sensitive scrolling. This timer may be much shorter than the timers used to change the scroll speed purely based on time. At the same time, it allows other functions such as tap for advancing one song at a time or a quick hard press that selects the desired song. The degree of sensitivity of the scrolling speed may be mapped to the applied force and may be adjusted based on the needs of the application.

For the selecting threshold, the level higher than the scrolling threshold may be set which defines a single event for Rising Edge. Also, while the user is scrolling, the action of pressing harder and exceeding the selected force of touch threshold levels would not activate selection since the user should stop and confirm the selection.

TABLE 6
Select Threshold Events

| Event | Action |
|---|---|
| Rising Edge | Select the current item in the list and perform whatever |
| | action is appropriate for the application. |

While the scrolling threshold would not need any other events, it may prevent any passing along to the Scrolling Threshold event handlers to avoid inadvertent scrolling when trying to select. An alternative implementation would be to implement the “Click” event for the Select Threshold.

### Example 5

### One Finger Pan-and-Zoom

Mobile and other devices are frequently used to examine very large images at varying degrees of zoom, such as in the case of navigation, where a map may need to be zoomed in or out and panned in various combinations to achieve the desired view. One of the most successful user interface gestures is the pinch gesture which allows a graphical object to be zoomed in or out based on two fingers coming together for zooming in and spreading apart for zooming out. While this gesture has enabled much-enhanced abilities for the user to manipulate a map or a photo, it does require two hands to operate on a mobile device since one hand is used to hold the device while the other hand makes the gesture. This can be a problem in situations where both hands are not available, such as when carrying luggage or driving a car. Another limitation of the pinch gesture is that it requires multiple repeated gestures to zoom in from a very large area of the map to a very detailed region.

The present invention uses the ability to measure the force that the operator applies to zoom in or out of an image such as a map or photo. It requires a one-finger contact and thus allows a one-handed operation, for example when the mobile device is held by the fingers and the thumb makes the contact with the surface. A low-level force is used to locate the contact of the finger to the graphical image (thus allowing the user to pan the image) and a high-level force controls the zoom function. In addition to advantageous one-handed operation, this gesture does not require multiple gestures to zoom in from a large area to a detailed region thus saving the user effort. The proportional control of the zoom function further allows the user to control the speed of zoom allowing to precisely selecting the desired view.

To zoom out, a separate region on the screen may be designated as a zoom-out button or a simple tap and press changes the zoom direction from zooming in to zooming out.

With tactile control methods of the invention, the different gestures may be combined together so that a single finger may be used to do both panning and zooming simultaneously. To implement this on a tactile control of the invention, two force thresholds may be used, one for panning, and another for zooming. A light touch may initiate pan only. A harder touch may activate zooming and panning, with the degree of zoom determined by the level of applied force.

The Pan Threshold control may only need a single event to detect changes in location while the applied force was at or above a predetermined force of touch threshold.

TABLE 7
Pan Threshold Events

| Event | Action |
|---|---|
| Move | Pan the view of the image based on the change in location. |

For the Zoom Threshold control, a time duration parameter may be specified to determine whether a tap action had been performed to change the zoom direction. A Double-Click in this case may be defined as two rising edges within the specified time duration.

TABLE 8
Zoom Threshold Events

| Event | Action |
|---|---|
| Rising Edge | Start the timer for detecting Double Click events and set |
| | zoom direction to zooming in. |
| Active | Each time the event is activated, zoom the image about |
| | the current location based on an amount determined |
| | by the applied force. |
| Double-Click | Set zoom direction to zooming out. |

The Double-Click event in this case may be activated after the Rising Edge event, so that the default behavior may always be to zoom in with increasing force. Double-Clicking may switch to zooming out until the control is released, at which point the zoom direction would revert back to zooming in—see FIG. 6.

### Example 6

### Adaptive Force Thresholds

Different activation thresholds of tactile controls may be adjusted over time according to the present invention allowing the overall force-sensitivity of a tactile input device to accommodate different users' grasp and input capabilities. Such adaptive functionality may increase usability of touch-enabled devices.

Determining the appropriate force thresholds for the various types of input gestures available in a tactile control may be based on one or a combination of four different sources:
Default values based on research, industry guidelines, or mechanical analysis of the hardware;
Using a “calibration” program to have the user perform various predefined gestures and then setting thresholds based on the input data;
Monitoring the force levels for different thresholds to try to detect deviations from the current thresholds and automatically updating them accordingly; or
Allowing the user to adjust thresholds by manual input of the force levels.

Default values may be determined by having a large population of users perform a set of gestures on a tactile input device, and then selecting thresholds that would accommodate the largest percentage of users.

A “gesture training” program may be used on a particular device to configure input thresholds for a specific combination of device and user. Optionally, the resulting data may be anonymously uploaded to the application developer to provide increased population data for determining default values, which may be “pushed” to other devices.

One limitation of calibration-type training programs is that users may not use the same motion or gesture as they may use when just using the device naturally. To help compensating for this limitation, a tactile input device of the invention may continually monitor the force inputs used on various types of tactile controls to determine automatically when adjustments may be necessary.

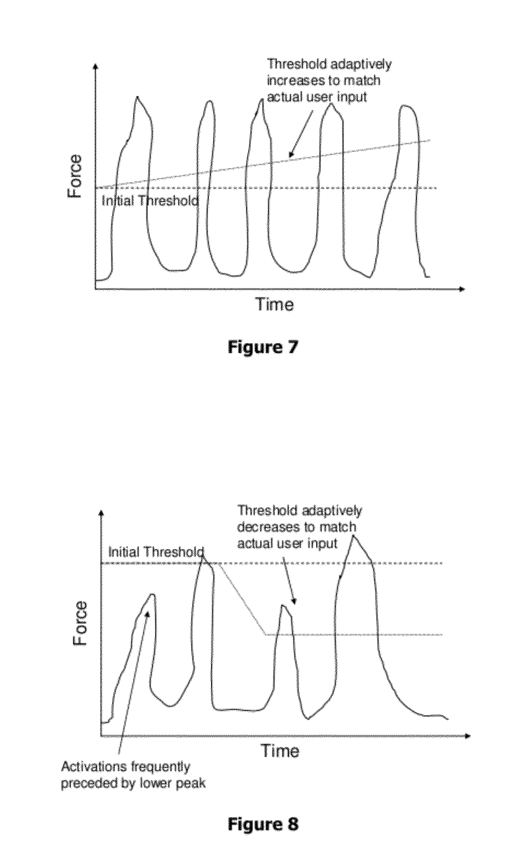

One method of adjusting thresholds according to the invention may include analyzing the actual applied force of touch for all inputs of a specific type. For example, if the “button” activation force is set initially at 300 g, but the device consistently measured that the user always used an actual force of 500 g or more when using button inputs, the force of touch threshold may be appropriately increased—see FIG. 7.

Another method may involve analyzing repeated gestures to detect errors. For example, if the activation force for tactile buttons is set initially at 400 g and the device detected that many button “clicks” were preceded by a peak force of 350 g on the same button, it may determine that for that user a force of touch threshold need to be reduced to below 350 g instead—see FIG. 8.

A particular tactile input device may implement one or all of these different methods of setting the event activation thresholds so as to better suit a particular user's needs.

Advantages of the above described methods include:
Multiple function operation with different levels of pressure and duration;
Manipulation of graphical user interface or GUI objects in a way similar to manipulating real objects;
Less steps required to cut and paste on a force-enabled touch screen;
Quicker and more accurate selection of items from a large list such as with song lists;
One-finger or one-thumb zoom and pan function;
Consistent user experience through adaptation for force thresholds.

### Example 7

### Force-Sensitive Acceleration Function for Gaming Applications

Smartphones may eventually replace hand-held gaming controls and consoles. One limitation of the contemporary smartphone is lack of accelerometer and in some cases lack of touchscreen when compared with hand-held gaming controls. In embodiments of the present invention, force-measuring sensors may be adapted to provide desired accelerometer function by measuring the level of the force of touch. In one example, a racing game may be improved by providing an acceleration control button responsive to the actually measured level of touch. Pushing harder on this button may activate a car or another object to move faster on the screen.

The advantage of this approach is achieving expanded functionality to facilitate rich gaming experience—but without increasing the physical size of the device or requiring other control hardware to be used concurrently with the main control panel. This makes using smartphones advantageous for gaming purposes.

### Example 8

### Basic Controls with Gloved Hands

A gloved finger presents a challenge to the present touch-screen input devices as capacitance measurement becomes problematic. The present invention provides for at least basic control function using a gloved hand by measuring a force of touch at a particular location. Using force sensors at the corners of the screen may allow calculating the location of touch by knowing the forces at all four corners—even without measuring such location using capacitance principles.

### Example 9

### Improved Handwriting and Note Taking

Tactile controls and methods of the invention may further be helpful in improving handwriting while in the drawing mode. In comparison to a fixed line width, adding the force allows the line width to vary similar to how a paint brush stroke, pencil or a pen works on paper thus providing more realistic signature and creative freedom.

### Implementation of the Invention

The invention describes a very general approach to interpreting tactile input data and may accommodate a wide variety of different types of input hardware and system platforms.

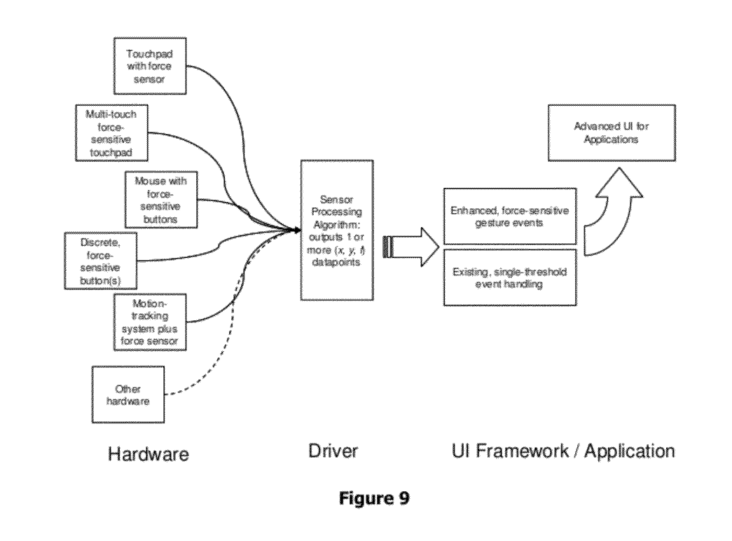

In its most general sense, the force gesture method described herein may be used with any hardware whose sensor data may be used to detect and collect one or more data points, each such data point including information about location and force of touch. This may be viewed as somewhat analogous to a computer mouse configured for generating location data plus the state of each of its buttons. The translation of the sensor inputs to location and force of touch may be provided by the hardware driver for a particular operating system, or it may be done by the GUI framework or even the application itself if the raw sensor data is made available. A sample implementation architecture concept is shown in FIG. 9.

Many different types of hardware may be used to generate the location and force of touch data, including but not limited to the following examples:
Touchpad/touchscreen with force sensing (the force output may be generated from a sensor mounted under the touchpad or by algorithms processing the touch data);
Multi-touch force-sensitive touchpad/touchscreen (e.g. a capacitive tactile array sensor providing force levels at each location in an M×N array);
Mouse with force-sensitive buttons (which may be configured to generate a separate output for each force-sensitive button with the same location);
Discrete, force-sensitive buttons (each button may have the equivalent of a fixed location, and each may be capable of generating tactile events; such hardware may be used on a point-of-sale system or a gaming controller with specialized input requirements);
Motion-tracking system with force sensing (an optical or inertial-based system may be configured to determine location, as is the case with many popular gaming consoles, while force measurement may be integrated with the controller or available as a separate component, such as a force plate under the user's feet).

The herein described subject matter sometimes illustrates different components or elements contained within, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Although the invention herein has been described with respect to particular embodiments, it is understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method of operating an input device, said device configured for detecting a location of touch and measuring a force of touch at said location, the method comprising a step of selecting either a first event or a second event as output of said input device based on said location of touch and said level of force of touch being above or below a predetermined threshold.

2. A method of operating an input device, said input device configured for detecting a location of touch and measuring a force of touch at said location, the method comprising a step of selecting one event from a plurality of events as an output of said input device based on said location of touch and said level of force of touch being above or below a predetermined plurality of thresholds, said plurality of events corresponding to said plurality of thresholds at said location of touch.

3. A method of operating an input device, said input device configured for detecting a location of touch and measuring a force of touch at said location, the method comprising:
a. providing at least one predetermined force of touch threshold within an operational range of said input device for at least one location of touch;
b. providing at least a first event corresponding to force of touch above said force of touch threshold and a second event corresponding to force of touch below said force of touch threshold for said at least one location of touch;
c. detecting location of touch and measuring force of touch; and
d. selecting either said first event as an output of said input device if said measured force of touch is above said force of touch threshold or said second event as the output of said input device if said force of touch is below said force of touch threshold.

4. The method as in claim 3, wherein said step (a) includes providing said at least one predetermined force of touch threshold for a plurality of locations of touch.

5. The method as in claim 3, wherein said step (a) including providing a plurality of predetermined force of touch thresholds corresponding to said location of touch, said step (b) including providing a number of events corresponding to the number of said predetermined force of touch thresholds, each event is associated to a range of force of touch values between adjacent force of touch thresholds, said step (d) further including determining which range of force of touch corresponds to said measured level of force of touch and selecting an event associated with said range of force of touch values.

6. The method as in claim 3, wherein said step (d) further including using additional selection criteria for selecting said event as an output of said input device.

7. The method as in claim 6, wherein said additional selection criteria is a duration of time during which said force of touch is detected as being above or below said force of touch threshold.

8. The method as in claim 3 further including a step of adjusting said force of touch threshold.

9. The method as in claim 8, wherein said step of adjusting said force of touch threshold is conducted in response to repeated measurements of the actual force of touch being consistently above or below said predetermined force of touch threshold.
